(19) United States
(12) Patent Application Publication
(10) Pub. No.: US 2020/0100457 A1
(43) Pub. Date: Apr. 2, 2020

(54) SYSTEM AND METHOD FOR COUPLING STRUCTURAL FEATURES TO A SMALL ANIMAL HABITAT

(71) Applicant: PetSmart Home Office, Inc., Phoenix, AZ (US)

(72) Inventors: Jeffrey Stocker Watson, Phoenix, AZ (US); Paul Tamulewicz, Glendale, AZ (US)

(21) Appl. No.: 16/568,046

(22) Filed: Sep. 11, 2019

Related U.S. Application Data
(60) Provisional application No. 62/739,687, filed on Oct. 1, 2018.

(51) Int. Cl. A01K 1/03

(52) U.S. Cl. CPC A01K 1/03

(57) ABSTRACT

A small animal habitat and method of coupling at least one decorative assembly to the small animal habitat. The small animal habitat includes a top portion, a base portion, and a central portion positioned therebetween, wherein the central portion includes a plurality of horizontally-extending wire tines. The small animal habitat also includes at least one exterior structural assembly, wherein the at least one exterior structural assembly has at least one upward-facing clip extending from an inner surface of the at least one exterior structural assembly, and at least one downward-facing extended tab extending from the inner surface of the at least one exterior structural assembly. The at least one upward-facing clip is configured to be removably coupled to at least one of the plurality of horizontally-extending wire tines, and the at least one downward-facing extended tab is configured to be removably coupled to the base portion.

### RELATED APPLICATIONS AND CLAIM OF PRIORITY

This patent document claims priority to U.S. Provisional Patent Application No. 62/739,687, filed Oct. 1, 2018, the disclosure of which is fully incorporated into this document by reference.

### BACKGROUND

The present disclosure relates generally to small animal habitats and, more particularly, to a system and method for coupling structural features to a small animal habitat.

Small animal habitats for housing pets such as, e.g., hamsters, gerbils, mice, rats, etc. are commonly found in many settings, and in an array of sizes and configurations. Generally, these habitats include multiple wall portions, a base portion, and a top shell portion, with at least one of the wall portions having a wire cage and/or one or more viewing windows to allow for visibility, airflow, etc. into the interior of the habitat. In some configurations, the top shell portion may form (or include) a lid, thereby allowing the pet owner to access the interior of habitat for cleaning, feeding, pet removal or replacement, etc. In other configurations, at least one of the top shell portion and the wall portions may have a door or hatch formed therein so as to allow owner access to the interior of the habitat.

Often, small animal habitats are relatively simple in shape and design, with cage-like configurations as described above. To many owners, habitats with unique themes and/or shapes may be desirable, further adding to their enjoyment of owning a pet. However, the cost and/or complexity of manufacturing an entire small animal habitat having such unique themes and/or shapes may be prohibitive, particularly given the fact that different owners may desire many different themes.

Accordingly, this patent document described devices that are intended to address the issues discussed above and/or other issues.

### SUMMARY

In accordance with one aspect of the disclosure, a small animal habitat is disclosed. The small animal habitat includes a top portion, a base portion, and a central portion positioned between the top portion and the base portion, wherein the central portion at least partially includes a plurality of horizontally-extending wire tines. The small animal habitat also includes at least one exterior structural assembly, wherein the at least one exterior structural assembly has at least one upward-facing clip extending from an inner surface of the at least one exterior structural assembly, and at least one downward-facing extended tab extending from the inner surface of the at least one exterior structural assembly. The at least one upward-facing clip is configured to be removably coupled to at least one of the plurality of horizontally-extending wire tines, and further wherein the at least one downward-facing extended tab is configured to be removably coupled to the base portion.

According to another aspect of the disclosure, a method of coupling at least one decorative assembly to the exterior of a small animal habitat is disclosed. The method includes providing a top portion, providing a base portion, and providing a central portion positioned between the top portion and the base portion, wherein the central portion at least partially includes a plurality of horizontally-extending wire tines. The method also includes providing at least one exterior structural assembly. The at least one exterior structural assembly may include at least one upward-facing clip extending from an inner surface of the at least one exterior structural assembly, and at least one downward-facing extended tab extending from the inner surface of the at least one exterior structural assembly. The method may further include coupling the at least one downward-facing extended tab to a surface of the base portion, and coupling the at least one upward-facing clip to at least one of the plurality of horizontally-extending wire tines.

### BRIEF DESCRIPTION OF THE DRAWINGS

FIG. 1 is a perspective view of a small animal habitat in accordance with an aspect of the disclosure;

FIG. 2 is a partially exploded view of the small animal habitat of FIG. 1;

FIG. 3A is a perspective view of a corner tower attachment for use with the small animal habitat of FIG. 1;

FIG. 3B is a detail view of upward facing tabs formed on an inner surface of the corner tower attachment of FIG. 3A;

FIG. 3C is a detail view of an extended base tab formed on an inner surface of the corner tower attachment of FIG. 3A;

FIG. 4A is a cross-sectional view of the small animal habitat having a corner tower attachment coupled therein in accordance with an aspect of the disclosure;

FIG. 4B is a detail view of a coupling interface between a cage portion of the small animal habitat and the upward facing tabs of the corner tower attachment in accordance with an aspect of the disclosure; and

FIG. 4C is a detail view of the extended base tab coupling the corner tower attachment to a base portion of the small animal habitat in accordance with an aspect of the disclosure.

### DETAILED DESCRIPTION

The following description is made for the purpose of illustrating the general principles of the present system and method and is not meant to limit the inventive concepts claimed in this document. Further, particular features described in this document can be used in combination with other described features in each of the various possible combinations and permutations.

Unless otherwise specifically defined in this document, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified. Unless defined otherwise, all technical and scientific terms used herein have the same meanings as commonly understood by one of ordinary skill in the art. All publications mentioned in this document are incorporated by reference. Nothing in this document is to be construed as an admission that the embodiments described in this document are not entitled to antedate such disclosure by virtue of prior invention. As used herein, the term “comprising” means “including, but not limited to”. Additionally, use the term “couple”, “coupled”, or “coupled to” may imply that two or more elements may be directly connected or may be indirectly coupled through one or more intervening elements.

In this document, position-identifying terms such as “vertical”, “horizontal”, “front”, “rear”, “side”, “top”, and “bottom” are not intended to limit the invention to a particular direction or orientation, but instead are only intended to denote relative positions, or positions corresponding to directions shown when a small animal habitat is oriented as shown in the Figures.

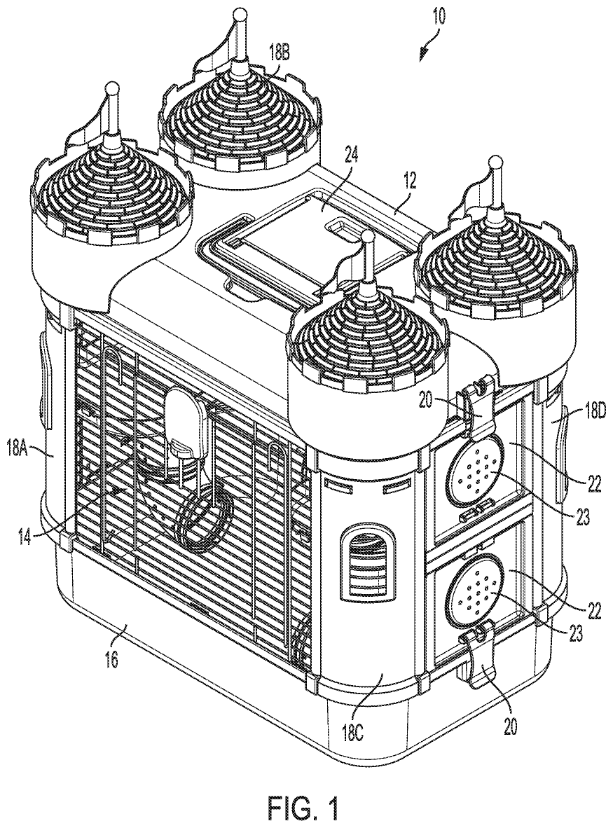

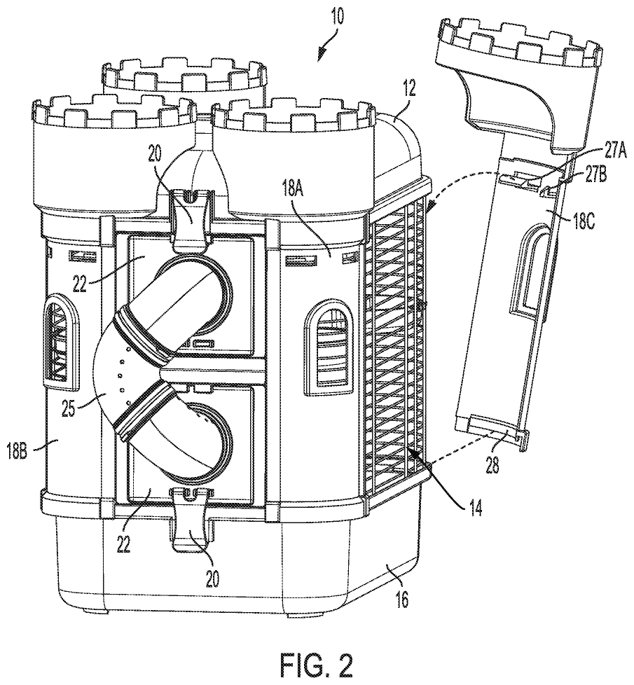

Referring to FIGS. 1-2, a small animal habitat 10 in accordance with an aspect of the disclosure is shown. Small animal habitat 10 may be configured to hold any appropriate type of small animal, such as, e.g., one or more hamsters, gerbils, mice, rats, etc. As illustrated, small animal habitat 10 is manufactured to resemble a castle, providing for a more unique and aesthetically appealing structure as compared to conventional cubic and/or cage-like small animal habitats. As will be set forth in further detail, the unique ornamental features of small animal habitat 10 (i.e., the castle towers) are sized and configured to be coupled to respective corners of a substantially conventional, cage-like small animal habitat, thereby providing for a unique aesthetic appearance without substantial alteration to existing small animal habitat configurations.

Small animal habitat 10 may include a primary habitat portion, which may be cage-like in configuration and include therein bedding material for the animal, feeding accessories, one or more hide structures, etc. Specifically, as shown in FIG. 1, small animal habitat 10 includes a top portion 12, a central portion 14, and a base portion 16. Central portion 14 may be formed of a plurality of closely-spaced wires so as to form the cage-like configuration. Alternatively, one or more walls of central portion 14 may be formed of a material other than wires, such as, e.g., clear or opaque plastic, etc.

One or both of top portion 12 and base portion 16 may be configured to be removably coupled to the central portion 14. For example, latches 20 may be provided so as to allow for selective removal of base portion 16 and/or top portion 12 from central portion 14, thereby allowing the user to easily access the interior of small animal habitat 10 in order to remove the small animal, clean the habitat, etc. While latches 20 are shown in FIG. 1 as being provided for removal of both the base portion 16 and the top portion 12, it is to be understood that the small animal habitat 10 may be configured such that only one of base portion 16 and top portion 12 is removable from central portion 14. Furthermore, top portion 12 may include a pivotable lid 24 formed at least partially therein so as to enable the user simplified access into the interior of the small animal habitat 10. The top portion 12, base portion 16, and/or lid 24 may be formed of any appropriate material, such as plastic, metal, a polymer, etc. Additionally and/or alternatively, top portion 12, base portion 16, and/or lid 24 may be formed so as to be opaque, clear, translucent, transparent, or any combination thereof.

As shown in FIGS. 1-2, the small animal housed within small animal habitat 10 is not necessarily confined to movement within the boundaries of top portion 12, central portion 14, and base portion 16. For example, as shown in FIG. 2, in some embodiments, one or more external tubes 25 may pass outside small animal habitat 10 through one or more of the sidewalls 22 of the central portion 14. The external tube(s) 25 may couple to the sidewalls 22 at the location of one or more selectively-removable caps 23, thereby enabling the user to customize and/or modify the length, routing, etc. of the external tubes 25. Furthermore, the user may utilize other external tubes to couple the small animal habitat 10 to other habitats or structures not shown in FIGS. 1-2.

Referring still to FIGS. 1-2, small animal habitat 10 may further include a plurality of decorative features coupled at the respective corners of the small animal habitat 10. Specifically, in accordance with an aspect of the disclosure, small animal habitat 10 may include external structural assemblies in the form of four castle tower assemblies 18A, 18B, 18C, 18D. Through inclusion of the castle tower assemblies 18A, 18B, 18C, 18D, small animal habitat 10 is visually transformed from a conventional, substantially cage-like configuration to one of a castle-like appearance, thereby providing a unique theme to further increase the user's enjoyment of pet ownership.

As noted above, the respective castle tower assemblies 18A, 18B, 18C, 18D are formed separately, each configured to be selectively attachable to respective corners of the small animal habitat 10. As shown in FIG. 2, and as will be set forth in further detail below, each castle tower assembly 18A, 18B, 18C, 18D includes an extended base tab 28 formed on an interior surface proximate a base portion of the castle tower assembly, along with a pair of upward-facing clips 27A, 27B formed proximate a top portion of the castle tower assembly. In some embodiments, upward-facing clips 27A, 27B may be vertically deflectable. Together, upward-facing clips 27A, 27B and extended base tab 28 are configured to securely (but removably) couple each respective castle tower assembly 18A, 18B, 18C, 18D to the small animal habitat 10, thereby simplifying manufacture of the small animal habitat 10 having a unique decorative appearance.

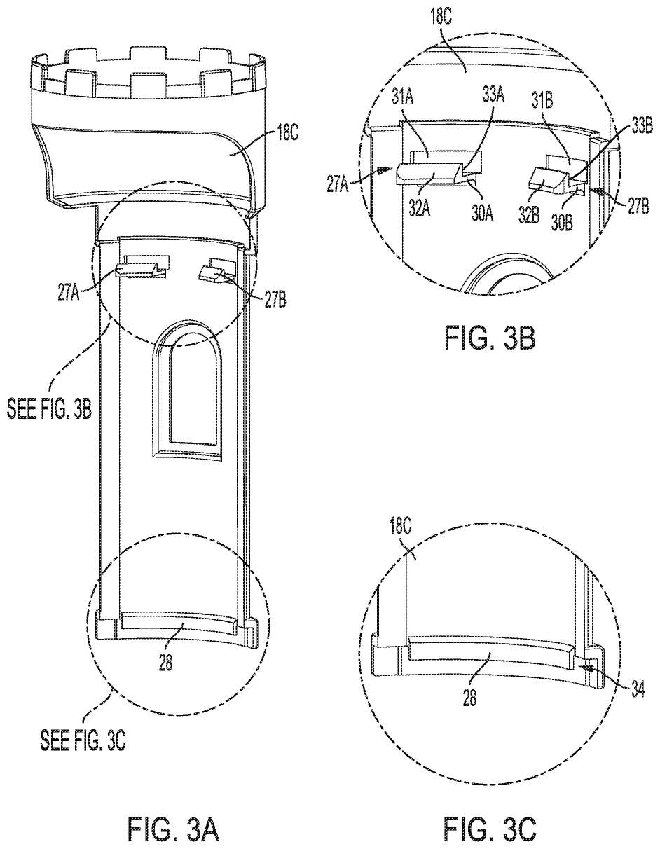

Referring to FIGS. 3A-3C, detailed views of castle tower assembly 18C in accordance with an aspect of the disclosure are illustrated. It is to be understood that the additional castle tower assemblies 18A, 18B, and 18D are similarly constructed and have been omitted only for clarity. As described above, the castle tower assembly 18C includes an extended base tab 28 formed on an interior surface proximate a base portion thereof. Castle tower assembly 18C also includes a pair of upward-facing clips 27A, 27B formed proximate a top portion. While two upward-facing clips 27A, 27B and one extended base tab 28 are illustrated and described herein, it is to be understood that more or fewer upward-facing clips and extended base tabs may be utilized in accordance with the disclosure.

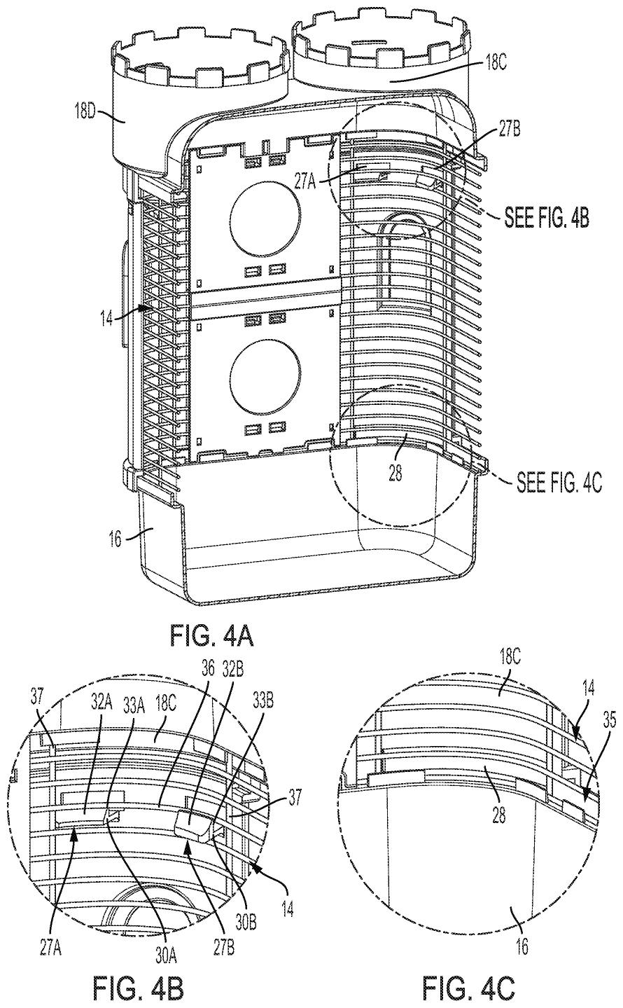

As shown in FIG. 3B, each upward-facing clip 27A, 27B includes a plurality of surfaces, with each surface acting in some fashion so as to allow the upward-facing clip 27A, 27B to be releasably coupled to the central portion 14 of small animal habitat 10. Specifically, upward-facing clips 27A, 27B include respective horizontally-extending surfaces 30A, 30B, which extend from an inner surface of the castle tower assembly 18C. At a distal end of horizontally-extending surfaces 30A, 30B, a respective angled face 32A, 32B extends upward so as to form a sliding interface between upward-facing clips 27A, 27B and a wire tine of central portion 14, as will be described in further detail below with respect to FIGS. 4A-4C. Substantially adjacent to angled faces 32A, 32B may be respective vertical faces 33A, 33B, which provide a substantially flat surface so as to retain upward-facing clips 27A, 27B on the central portion 14 when castle tower assembly 18C is installed.

Additionally, respective openings 31A, 31B may be provided proximate upward-facing clips 27A, 27B. Openings 31A, 31B may be configured to provide the user with access to upward-facing clips 27A, 27B from an outer surface of castle tower assembly 18C, allowing the user to deflect the upward-facing clips 27A, 27B in a downward direction (either via a tool or tool-lessly), thereby disengaging respective vertical faces 33A, 33B from the central portion 14 so as to allow the castle tower assembly 18C to be selectively removable by the user. Alternatively, in other embodiments, instead of deflecting the upward-facing clips 27A, 27B, the openings 31A, 31B may provide access to the wire tine to which the clips 27A, 27B are engaged, allowing the user to deflect the wire tine (either via a tool or tool-lessly) in an upward direction so as to disengage vertical faces 33A, 33B and enable removal of the castle tower assembly 18C from the central portion 14.

Referring to FIG. 3C, extended base tab 28 is formed on an interior surface proximate a base portion of castle tower assembly 18C. Unlike upward-facing clips 27A, 27B, extended base tab 28 opens in a downward-facing direction, forming a channel 34 between an inner surface of the castle tower assembly 18C and the extended base tab 28. As will be described further below with respect to FIGS. 4A-4C, extended base tab 28 (and associated channel 34) is sized and configured so as to fit over a top edge portion of base portion 16, thereby aiding to secure the castle tower assembly 18C to the small animal habitat 10.

Turning to FIGS. 4A-4C, detailed views of the interface between castle tower assembly 18C and the central portion 14 in accordance with an aspect of the disclosure are shown. To install castle tower assembly 18C onto the small animal habitat 10, the extended base tab 28 may first be placed over a top edge 35 of base portion 16 such that extended base tab 28 provides a secure but removable interface between a bottom portion of castle tower assembly 18C and the base portion 16, as shown in FIG. 4C.

Then, the upper portion of castle tower assembly 18C may be moved in the direction of the horizontal wire tines 36 of central portion 14, as shown in FIG. 4B. In some embodiments, as the respective angled surfaces 32A, 32B contact one of the horizontal wire tines 36, the upward-facing clips 27A, 27B are deflected downward until an end of the angled surfaces 32A, 32B is reached, at which point the upward-facing clips 27A, 27B naturally snap back to their undeflected position. Alternatively, in other embodiments, as the respective angled surfaces 32A, 32B contact one of the horizontal wire tines 36, the horizontal wire tine 36 deflects upward until an end of the angled surfaces 32A, 32B is reached, at which point the horizontal wire tine 36 naturally snaps back to an undeflected position. In either embodiment, the vertical faces 33A, 33B of respective upward-facing clips 27A, 27B are configured to securely hold the upper portion of castle tower assembly 18C in place, thereby providing a firm (but removable) interface between the castle tower assembly 18C and the central portion 14. As detailed above, the upward-facing clips 27A, 27B and/or the horizontal wire tines 36 may be accessed through respective openings 31A, 31B, thereby allowing a user to manually deflect the upward-facing clips 27A, 27B downward and/or the horizontal wire tines 36 upward, thereby disengaging the vertical faces 33A, 33B from the horizontal wire tines 36 to allow for selective removal of the castle tower assembly 18C.

Additionally and/or alternatively, the central portion may include vertical wire tines 37, with the upward-facing clips 27A, 27B sized and spaced relative to one another so as not to directly contact the vertical wire tines 37, but to fit therebetween so as to limit potential horizontal movement of the castle tower assembly 18C relative to the central portion 14. Furthermore, the base tab 28 may be similarly sized and spaced relative to vertical tines 37.

Accordingly, utilizing the interface described above with respect to FIGS. 3A-4C, each castle tower assembly 18A, 18B, 18C, 18D may be removably coupled to the small animal habitat, providing for a habitat having a unique aesthetic theme, yet one which is customizable and simple to construct/deconstruct.

While castle tower assemblies 18A, 18B, 18C, 18D are shown and described with respect to FIGS. 1-4C, it is to be understood that other themed assemblies would also be applicable to the interface configuration described herein. For example, the themed assemblies may include one or more barn silos, one or more house walls, one or more rockets, etc.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the disclosure. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A small animal habitat comprising:
a top portion;
a base portion;
a central portion positioned between the top portion and the base portion, wherein the central portion at least partially comprises a plurality of horizontally-extending wire tines; and
at least one exterior structural assembly, wherein the at least one exterior structural assembly comprises:
at least one upward-facing clip extending from an inner surface of the at least one exterior structural assembly, and
at least one downward-facing extended tab extending from the inner surface of the at least one exterior structural assembly,
wherein the at least one upward-facing clip is configured to be removably coupled to at least one of the plurality of horizontally-extending wire tines, and further wherein the at least one downward-facing extended tab is configured to be removably coupled to the base portion.

2. The small animal habitat of claim 1, wherein the at least one upward-facing clip comprises a horizontally-extending surface, an upwardly-extending angled surface, and a vertically-extending face.

3. The small animal habitat of claim 2, wherein the at least one upward-facing clip is downwardly deflectable.

4. The small animal habitat of claim 2, wherein the at least one exterior structural assembly further comprises at least one opening formed therein, the at least one opening formed proximate the at least one upward-facing clip so as to provide external access to the at least one upward-facing clip.

5. The small animal habit of claim 1, wherein a channel is formed between the at least one downward-facing extended tab and the inner surface of the at least one exterior structural assembly.

6. The small animal habitat of claim 5, wherein the channel is sized to fit over a top edge of the base portion.

7. The small animal habitat of claim 1, wherein the at least one exterior structural assembly comprises at least one castle tower assembly.

8. The small animal habitat of claim 1, wherein the at least one exterior structural assembly comprises four castle tower assemblies.

9. The small animal habitat of claim 1, wherein the at least one upward-facing clip comprises a pair of spaced-apart upward-facing clips.

10. The small animal habitat of claim 9, wherein the pair of spaced-apart upward-facing clips are configured to be positioned between a pair of vertical wire tines of the central portion.

11. The small animal habitat of claim 1, wherein the at least one downward-facing extended tab comprises a single downward-facing extended tab.

12. The small animal habitat of claim 11, wherein the downward-facing extended tab is configured to be positioned between a pair of vertical wire tines of the central portion.

13. The small animal habitat of claim 1, wherein at least one of the top portion and the base portion is removably coupled to the central portion.

14. The small animal habitat of claim 13, further comprising at least one latch, wherein the at least one latch is configured to removably secure at least one of the top portion and the base portion to the central portion.

15. A method of coupling at least one decorative assembly to the exterior of a small animal habitat, the method comprising:
providing a top portion;
providing a base portion;
providing a central portion positioned between the top portion and the base portion, wherein the central portion at least partially comprises a plurality of horizontally-extending wire tines;
providing at least one exterior structural assembly, wherein the at least one exterior structural assembly comprises:
at least one upward-facing clip extending from an inner surface of the at least one exterior structural assembly, and
at least one downward-facing extended tab extending from the inner surface of the at least one exterior structural assembly,
coupling the at least one downward-facing extended tab to a surface of the base portion; and
coupling the at least one upward-facing clip to at least one of the plurality of horizontally-extending wire tines.

16. The method of claim 15, wherein coupling the at least one downward-facing extended tab to a surface of the base portion comprises coupling the at least one downward-facing extended tab to a top edge of the base portion.

17. The method of claim 15, wherein the at least one upward-facing clip comprises a horizontally-extending surface, an upwardly-extending angled surface, and a vertically-extending face, and further wherein coupling the at least one upward-facing clip comprises deflecting the horizontally-extending surface until the vertically-extending face engages with at least one of the plurality of horizontally-extending wire tines.

18. The method of claim 15, wherein the at least one upward-facing clip comprises a horizontally-extending surface, an upwardly-extending angled surface, and a vertically-extending face, and further wherein coupling the at least one upward-facing clip comprises deflecting at least one of the plurality of horizontally-extending wire tines in an upward direction until the vertically-extending face engages with the at least one of the plurality of horizontally-extending wire tines.
